(19) United States
(12) Patent Application Publication
(10) Pub. No.: US 2018/0225049 A1
(43) Pub. Date: Aug. 9, 2018

(54) MEDIA RECORDING SYSTEMS

(71) Applicant: Sensors Unlimited, Inc., Princeton, NJ (US)

(72) Inventors: Andrew Eckhardt, Richboro, PA (US); Jinguo Yu, Flemington, NJ (US)

(21) Appl. No.: 15/424,502

(22) Filed: Feb. 3, 2017

(51) Int. Cl. G06F 3/06

(52) U.S. Cl. CPC G06F 3/0613; G06F 3/0673; G06F 3/0653; G06F 3/0638

(57) ABSTRACT

A method includes writing sample data from a media recording device to a digital memory card, wherein the sample data includes predetermined characteristics, determining a length of write time to write the sample data to the digital memory card, and calculating actual write speed between the media recording device and the digital memory card. In certain embodiments, writing the sample data can include writing the sample data from a sample module of a media recording device to the digital memory card.

### BACKGROUND

### 1. Field

The present disclosure relates to data storage, more specifically to media recording systems (e.g., for digital cameras).

### 2. Description of Related Art

Removable recording media are available in the common SD card physical format which has a wide range of write speed ratings. Further, because of market factors and various recording formats used the actual recording speed may vary considerably from advertised ratings. For those reasons users of such media cannot easily determine correct settings or recording performance.

Such conventional methods and systems have generally been considered satisfactory for their intended purpose. However, there is still a need in the art for improved media recording systems. The present disclosure provides a solution for this need.

### SUMMARY

A method includes writing sample data from a media recording device to a digital memory card, wherein the sample data includes predetermined characteristics, determining a length of write time to write the sample data to the digital memory card, and calculating actual write speed between the media recording device and the digital memory card. In certain embodiments, writing the sample data can include writing the sample data from a sample module of a media recording device to the digital memory card.

Writing the sample data can include writing the sample data upon startup of the media recording device. The method can include adjusting a data compression ratio dynamically to maintain a data transfer rate that does not exceed the actual write speed between the media recording device and the digital memory card.

The media recording device can include a video camera. In such embodiments, adjusting a data compression ratio can include adjusting a video compression ratio dynamically to maintain a video recording quality such that the data transfer rate does not exceed the actual write speed between the media recording device and the digital memory card, for example. In certain embodiments, adjusting the video compression ratio includes adjusting the video compression ratio such that video recording quality is highest allowed to cause the data transfer rate to be maximized but not to exceed the actual write speed between the media recording device and the digital memory card.

Writing sample data to the digital memory card can include writing sample data to an SD card. In certain embodiments, the method can include displaying the actual write speed data to a user.

A media recording device can include a sample data module stored on a non-transitory computer readable medium of the media recording device and configured to execute any suitable method and/or portion thereof as described above. The device can include a control module configured to adjust a data compression ratio dynamically to maintain a data transfer rate that does not exceed the actual write speed between the media recording device and the digital memory card.

In certain embodiments, the media recording device can include a video camera. The control module can be configured to adjust a video compression ratio dynamically to maintain a video recording quality such that the data transfer rate does not exceed the actual write speed between the media recording device and the digital memory card. In certain embodiments, the control module can be configured to adjust the video compression ratio such that video recording quality is highest allowed to cause the data transfer rate to be maximized but not to exceed the actual write speed between the media recording device and the digital memory card.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a flow diagram of an embodiment of a method in accordance with this disclosure; and

FIG. 2 is a schematic diagram of a device in accordance with this disclosure.

### DETAILED DESCRIPTION

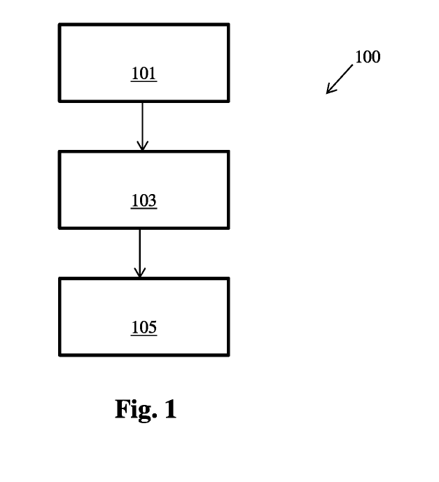

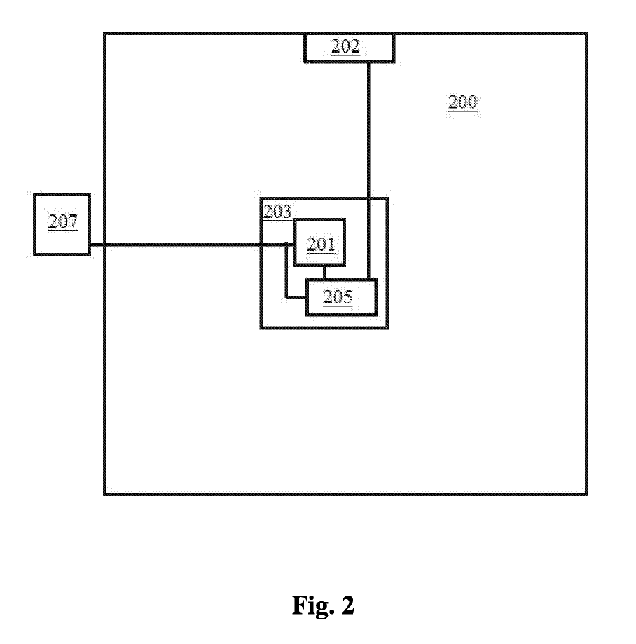

Reference will now be made to the drawings wherein like reference numerals identify similar structural features or aspects of the subject disclosure. For purposes of explanation and illustration, and not limitation, an illustrative view of an embodiment of a method in accordance with the disclosure is shown in FIG. 1 and is designated generally by reference character 100. Other embodiments and/or aspects of this disclosure are shown in FIG. 2. The systems and methods described herein can be used to improve data transfer (e.g., for video recorders).

Referring to FIG. 1, a method 100 includes writing (e.g., at block 101) sample data from a media recording device to a digital memory card. The sample data includes predetermined characteristics (e.g., data size). The method 100 also includes determining (e.g., at block 103) a length of write time to write the sample data to the digital memory card. The method also includes calculating (e.g., at block 105) actual write speed between the media recording device and the digital memory card. In certain embodiments, writing (e.g., at block 101) the sample data can include writing the sample data from a sample module of a media recording device to the digital memory card.

Writing (e.g., at block 101) the sample data can include writing the sample data upon startup of the media recording device. In certain embodiments, the method can include adjusting a data compression ratio dynamically to maintain a data transfer rate that does not exceed the actual write speed between the media recording device and the digital memory card.

The media recording device can include a video camera (e.g., any suitable imaging system) and/or any other suitable device (e.g., an audio recording device). Adjusting a data compression ratio can include adjusting a video compression ratio dynamically to maintain a video recording quality such that the data transfer rate does not exceed the actual write speed between the media recording device and the digital memory card, for example. In certain embodiments, adjusting the video compression ratio includes adjusting the video compression ratio such that video recording quality is highest allowed to cause the data transfer rate to be maximized but not to exceed the actual write speed between the media recording device and the digital memory card.

Writing (e.g., at block 101) sample data to the digital memory card can include writing sample data to a digital memory card such as a secure digital (SD) card, for example. In certain embodiments, the method can include displaying the actual write speed data to a user.

Referring to FIG. 2, a media recording device 200 can include a sample data module 201 (e.g., stored on a non-transitory computer readable medium 203 of the media recording device 200). The sample data module 201 can be configured to execute any suitable method and/or portion thereof as described above (e.g., blocks 101, 103, and 105 of method 100).

The device 200 can include a control module 205 configured to adjust a data compression ratio dynamically to maintain a data transfer rate that does not exceed the actual write speed between the media recording device and the digital memory card 207. The control module 205 can be connected to a recording system 202 (e.g., an imaging device) of the media recording device 200. In one embodiment the digital memory card 207 is configured to be easily removed from the device 200.

In certain embodiments, the media recording device 200 can include a video camera for example. In certain embodiments, the control module 205 can be operatively connected to the sample data module 201 (e.g., to receive the actual write speed from the sample data module 201).

The control module 205 can be configured to adjust a video compression ratio dynamically to maintain a video recording quality such that the data transfer rate does not exceed the actual write speed between the media recording device and the digital memory card 207 (e.g., an SD card). In certain embodiments, the control module 205 can be configured to adjust the video compression ratio such that video recording quality is highest allowed to cause the data transfer rate to be maximized but not to exceed the actual write speed between the media recording device and the digital memory card 207.

Any suitable hardware and/or software systems are contemplated herein. In certain embodiments, a JPEG encoder in a video camera can have an ENC_LENGTH_REG which reports the length of each coded frame in bytes. This register at the end of each frame can be read and compared to the frame length to maximum size supported by the installed digital memory card 207 at the operating frame rate. As such, embodiments can include comparing frame size from ENC_LENGTH_REG to maximum supported size determined at boot time. If frame size exceeds maximum size, the current frame can be skipped and not record it on the digital memory card. Instead, a JPEG quantization table pair can be selected that has a higher compression ratio and can be written to a JPEG encoder quantization RAM. The frame size can then be continually monitored on following frames. When frame size is less than maximum size, the quantization table can be accessed again to find a pair with a lower compression ratio to maximize playback image quality. If frame size is less than the maximum size and a default table is loaded, no action may be taken.

As appreciated by those having ordinary skill in the art, and digital memory card speed class markings are based on manufacturer tests. They may represent a best case scenario rather than real world performance. For example, popular file formats for video recording (e.g., FAT16 or vFAT format) may use linked-list structures in which the storage units or sectors may not be recorded sequentially, which results in longer write access times for traversing the linked list. Certain recording functions of certain devices compresses video in order to reduce SD card write speed requirement. Recording video camera video, for example, requires minimum write speed. There is a tradeoff between playback quality and recording speed. Higher image quality requires higher recording speed. For example, the size of video frames output by an MJPEG encoder is determined by a pair (one for Luma and one for Chroma) of 64-byte Quantization tables which are part of the software controlled configuration of the JPEG Encoder.

Certain embodiments perform a timed write of known data such as compressed video images to the SD card. This may be done once at camera boot time, or can be done at any suitable time and/or interval. The speed determined can be the limit of the maximum size of a JPEG compressed frame which can be written to the SD card at the operating frame rate of the video camera, for example.

As described above, embodiments allow determining the actual write speed capability of a digital memory card (e.g., an SD card) as opposed to its advertised rating and present condition, and can adjusting video compression ratio to an optimum level consistent with the digital memory card capability. In embodiments, each time the recording device is powered on, there is written a measured amount of data to the digital memory card. In embodiments, the length of time required to write the data is taken and used to calculate actual writing speed. Embodiments include a control module that can adjust video compression ratio dynamically so that video recording quality is highest consistent with the write speed limit of the installed SD card, for example.

By automatically adapting video recording speed to compensate for differences in SD cards, overall recording quality is higher. Also the user is ensured that data is not lost or cut off when the video recorder gets too close to the write speed limit of the installed card. Secondary benefit is that write speed can be reported to the user as confirmation that the card is ready and in good condition for recording.

As will be appreciated by those skilled in the art, aspects of the present disclosure may be embodied as a system, method or computer program product. Accordingly, aspects of this disclosure (e.g., modules as described above) may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the this disclosure are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

The methods and systems of the present disclosure, as described above and shown in the drawings, provide for media recording systems and methods with superior properties. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A method, comprising:
writing sample data from a media recording device to a digital memory card, wherein the sample data includes predetermined characteristics;
determining a length of write time to write the sample data to the digital memory card;
and
calculating actual write speed between the media recording device and the digital memory card.

2. The method of claim 1, wherein writing the sample data includes writing the sample data from a sample module of the media recording device to the digital memory card.

3. The method of claim 2, wherein writing the sample data includes writing the sample data upon startup of the media recording device.

4. The method of claim 1, further comprising adjusting a data compression ratio dynamically to maintain a data transfer rate that does not exceed the actual write speed between the media recording device and the digital memory card.

5. The method of claim 5, wherein the media recording device includes a video camera.

6. The method of claim 5, wherein adjusting a data compression ratio includes adjusting a video compression ratio dynamically to maintain a video recording quality such that the data transfer rate does not exceed the actual write speed between the media recording device and the digital memory card.

7. The method of claim 6, wherein adjusting the video compression ratio includes adjusting the video compression ratio such that video recording quality is highest allowed to cause the data transfer rate to be maximized but not to exceed the actual write speed between the media recording device and the digital memory card.

8. The method of claim 1, wherein writing sample data to the digital memory card includes writing sample data to an SD card.

9. The method of claim 1, further comprising displaying the actual write speed data to a user.

10. A media recording device, comprising:
a sample data module stored on a non-transitory computer readable medium configured to execute a method, the method including:
writing sample data to a digital memory card, wherein the sample data includes predetermined characteristics;
determining a length of write time to write the sample data to the digital memory card; and
calculating actual write speed between the media recording device and the digital memory card.

11. The device of claim 10, wherein writing the sample data includes writing the sample data upon startup of the media recording device.

12. The device of claim 10, comprising a control module configured to adjust a data compression ratio dynamically to maintain a data transfer rate that does not exceed the actual write speed between the media recording device and the digital memory card.

13. The device of claim 12, wherein the media recording device includes a video camera.

14. The device of claim 13, wherein the control module is configured to adjust a video compression ratio dynamically to maintain a video recording quality such that the data transfer rate does not exceed the actual write speed between the media recording device and the digital memory card.

15. The device of claim 14, wherein the control module is configured to adjust the video compression ratio such that video recording quality is highest allowed to cause the data transfer rate to be maximized but not to exceed the actual write speed between the media recording device and the digital memory card.
